(19) United States
(12) Patent Application Publication
(10) Pub. No.: US 2020/0037741 A1
(43) Pub. Date: Feb. 6, 2020

(54) Pre-Packaged and Pre-Loaded Paint Applicators

(71) Applicant: Joe Palmer, Columbus, OH (US)

(72) Inventor: Joe Palmer, Columbus, OH (US)

(21) Appl. No.: 16/052,066

(22) Filed: Aug. 1, 2018

(51) Int. Cl. A46B 11/00; B05C 17/02; B05C 1/06; A46B 7/04; B65D 81/20; B65B 31/02

(52) U.S. Cl. CPC A46B 11/0003; B05C 17/0207; B65B 31/024; A46B 7/04; B65D 81/2023; B05C 1/06

(57) ABSTRACT

A pre-packaged and pre-loaded paint applicator includes a vacuum sealed package and a new paint applicator sealed within the vacuum-sealed package. The new paint applicator has a paint receiving portion pre-loaded with paint. The paint applicator is removed from the vacuum-sealed package and used when only the relatively small amount of paint that is pre-loaded onto the paint applicator is needed. The pre-packaged and pre-loaded paint applicator can be useful in applications such as, for example, paint samples, paint touch up, and the like.

### CROSS-REFERENCE TO RELATED APPLICATIONS

Not Applicable

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to paint containers and the like and, more particularly, to paint containers for relatively small quantities of paint such as for paint samples, touch-up, and the like.

### BACKGROUND OF THE INVENTION

When trying to decide which color to paint walls, ceilings etc. in a home, homeowners often compare paint samples side by side to get a preview of the differences between the paint colors and how the wall, ceiling or other item will appear once painted. The types of paint samples typically available are paint chips, paint fans, and paint testers. Paint chips are loose squares or rectangles having the paint color. They are typically printed paper and do not have actual paint so there can be a wide variation from the actual paint color. Paint fans are pallets of bound paint swatches arranged in graduated form. The swatches are actually painted so there should not be any variation from the actual paint unless it is old and faded etc. However, it is still difficult to see what the actual wall would look like when painted in each color. Paint testers are small containers of paint that can be used to paint a portion of the actual wall to be painted. Thus, it provides a realistic view of what the wall will look like once fully painted.

While the paint testers may provide the most realistic view of what the wall will look like once fully painted, paint samples or testers are currently sold in cans or bottles in sizes typically ranging from 8 ounces to a quart. Therefore, most of the paint is discarded after using only a small fraction of the quantity of paint supplied. This is wasteful and not environmentally friendly.

Additionally, the paint testers are typically produced onsite at a retailer when requested by a consumer. Since each color of the paint must be custom mixed and packaged it can be very time consuming and thus the consumer may need to with a considerable period of time or return for pick-up at a later time. It also takes up the time of the retail clerk who must prepare each order on site.

Accordingly, there is a need in the art for improved paint samples and the like and/or methods of preparing and providing paint samples.

### SUMMARY OF THE INVENTION

Disclosed are containers and methods for providing paint that overcome at least one of the disadvantages of the prior art described above. Disclosed is a pre-packaged paint applicator comprising, in combination, a vacuum sealed package, and a new paint applicator sealed within the vacuum-sealed package and having a paint receiving portion pre-loaded with paint.

Also disclosed is a method for providing a paint sample comprising the steps of, in combination, pre-loading a paint receiving portion of a new paint applicator with paint, placing the pre-loaded paint receiving portion of the new paint applicator into a package, withdrawing air from the package and vacuum sealing the pre-loaded paint receiving portion of the new paint applicator within the package, and distributing the pre-packaged and pre-loaded paint applicator.

Further disclosed is a kit comprising, in combination, a plurality of pre-packaged paint applicators each comprising a vacuum sealed package and a new paint applicator sealed within the vacuum-sealed package and having a paint receiving portion pre-loaded with paint.

From the foregoing disclosure and the following more detailed description of various preferred embodiments it will be apparent to those skilled in the art that the present invention provides a significant advance in the technology and art of containers and methods for providing paint. Particularly significant in this regard is the potential the invention affords for providing small quantities of paint that not only reduce waste, but also can be shipped easily and inexpensively to retail establishments and directly to consumers. Additional features and advantages of various preferred embodiments will be better understood in view of the detailed description provided below.

### BRIEF DESCRIPTION OF THE DRAWINGS

These and further features of the present invention will be apparent with reference to the following description and drawings.

FIG. 1 is a view of a pre-packaged and pre-loaded paint applicator according to a first embodiment of the present invention.

FIG. 2 is a sectional view of the pre-packaged and pre-loaded paint applicator of FIG. 1 taken along line 2-2 of FIG. 1.

FIG. 3 is a view of the pre-loaded paint applicator of FIGS. 1 and 2 about to be secured to a handle.

FIG. 4 is a view of the pre-loaded paint applicator of FIGS. 1 to 3 secured to the handle of FIG. 3 and ready to paint.

FIG. 5 is a view of a pre-packaged and pre-loaded paint applicator according to a second embodiment of the present invention.

FIG. 6 is a sectional view of the pre-packaged and pre-loaded paint applicator of FIG. 5 taken along line 6-6 of FIG. 5.

FIG. 7 is a view of the pre-loaded paint applicator of FIGS. 5 and 6 about to be secured to a handle.

FIG. 8 is a view of the pre-loaded paint applicator of FIGS. 5 to 7 secured to the handle of FIG. 7 and ready to paint.

FIG. 9 is a view of a pre-packaged and preloaded paint applicator according to a third embodiment of the present invention.

FIG. 10 is a sectional view of the pre-packaged and pre-loaded paint applicator of FIG. 9 taken along line 10-10 of FIG. 9.

FIG. 11 is a view of the pre-loaded paint applicator of FIGS. 9 and 10 about to be secured to a handle.

FIG. 12 is a view of the pre-loaded paint applicator of FIGS. 9 to 11 secured to the handle of FIG. 11 and ready to paint.

FIG. 13 is a view of a kit comprising a plurality of the pre-packaged and pre-loaded paint applicators and a single handle for use with the paint applicators.

It should be understood that the appended drawings are not necessarily to scale, presenting a somewhat simplified representation of various preferred features illustrative of the basic principles of the invention. The specific design features of the paint samples as disclosed herein, including, for example, specific dimensions and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the paint samples illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the paint samples disclosed herein. The following detailed discussion of various alternative and preferred embodiments will illustrate the general principles of the invention with regard to paint samples. Other embodiments suitable for other applications will be apparent to those skilled in the art given the benefit of this disclosure, for example a loaded paint brush head or the like.

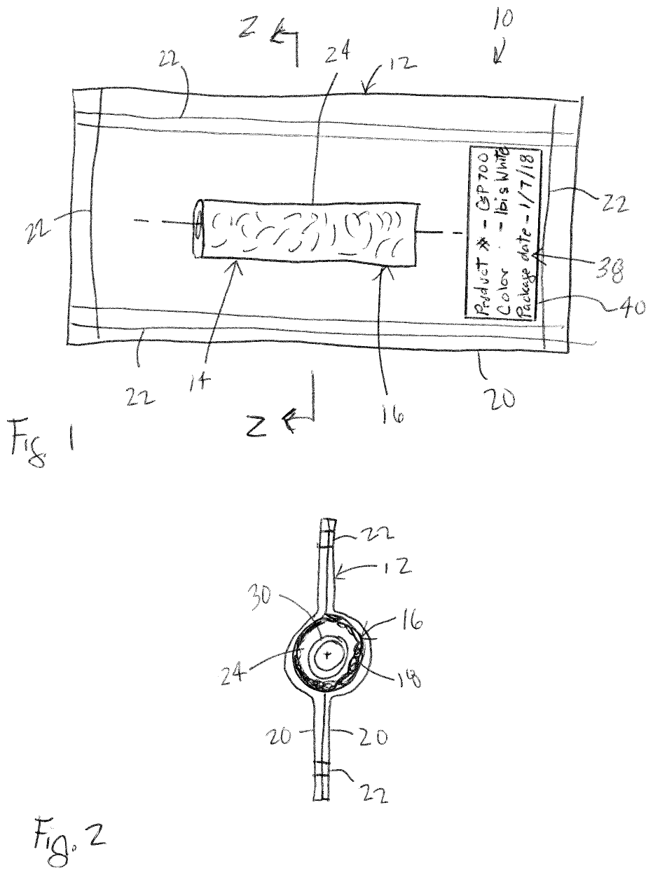

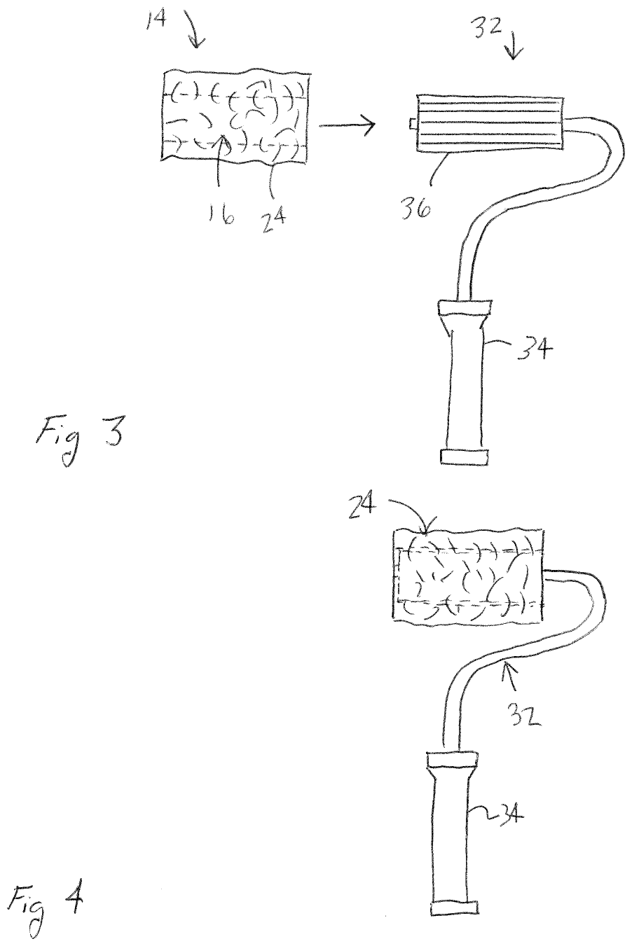

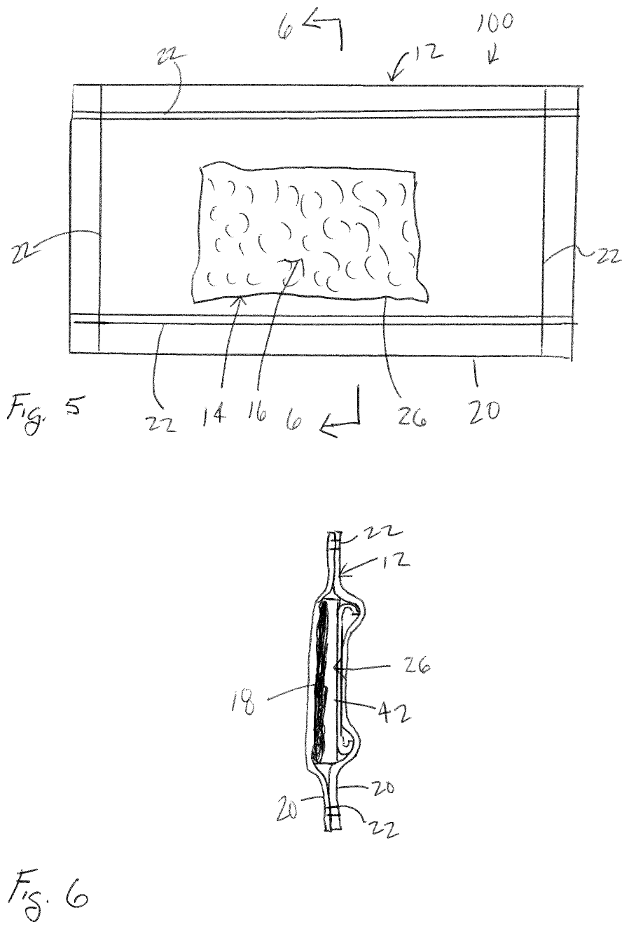

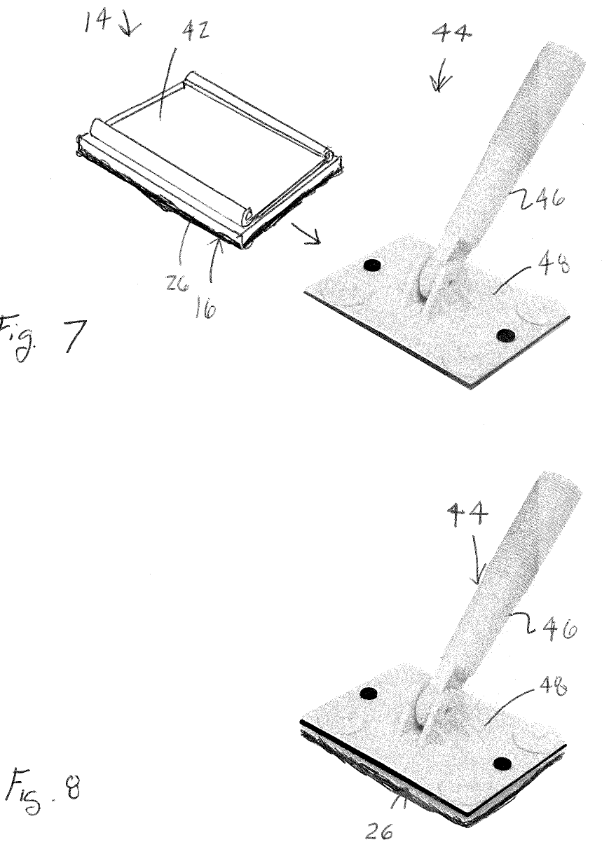

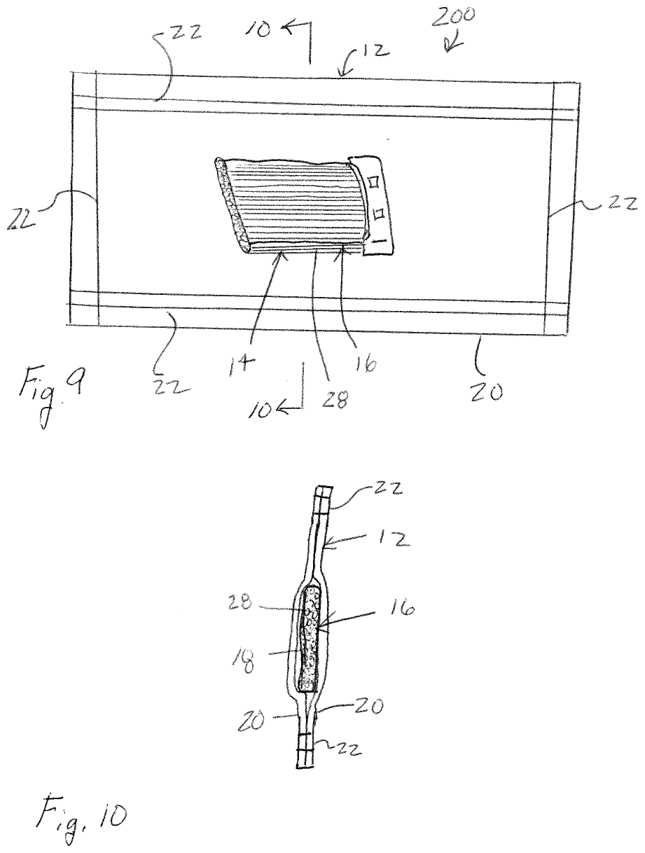

FIGS. 1 and 2 illustrate a pre-packaged and pre-loaded paint applicator assembly 10 according to a first embodiment of the present invention. The illustrated pre-packaged and pre-loaded paint applicator includes 10 a vacuum-sealed package 12 and a new paint applicator 14 sealed within the vacuum-sealed package 12 and having a paint receiving portion 16 pre-loaded with paint 18. The term “pre-packaged” is used herein and in the claims to means packaged before retail distribution or sale. The term “pre-loaded” is used herein and in the claims to mean loaded with paint by any means in advance of packaging and at a time removed from that of use. The term “new” is used herein and in the claims to mean not previously used for its intended purpose of applying paint to a surface other than when while being loaded with paint prior to being packaged.

The illustrated vacuum-sealed package 12 is a vacuum-sealed bag but any other suitable type of vacuum-sealed package can alternatively be utilized. The illustrated vacuum-sealed bag 12 is formed from two generally planar side walls or sheets 20 of plastic which are each rectangular shaped but any other suitable shape or configuration can alternatively be utilized. The two plastic sheets 20 are positioned generally back-to-back and sealed together about the perimeter to form a vacuum-sealed interior cavity between the two plastic sheets 20 for holding the pre-loaded new paint applicator 14. The illustrated plastic sheets 20 are sealed or secured together with four thermal or heat welds 22 with one of the four heat welds extending along each of the four edges of the rectangular-shaped plastic sheets 20. It is noted that the plastic sheets 20 can alternatively be sealed together in any other suitable manner and/or the thermal or heat welds 22 can alternatively have any other suitable configuration.

The illustrated plastic sheets 20 comprise a non-porous material having a low oxygen transmission rate (OTR) including but not limited to nylon, EVOH (ethylene vinyl alcohol), Biax-nylon-6, OPET (oriented polyester), and the like. A material is considered a “high oxygen barrier” if its oxygen transmission rate is less than 1 cc/100 in²/24 hr. The plastic sheets 20 preferably have an OTR of about 3 cc/100 in²/24 hr or less, more preferably have an OTR of about 2 cc/100 in²/24 hr or less, and most preferably have an OTR of about 1 cc/100 in²/24 hr. The plastic sheets 20 can have any suitable thickness and any suitable number of one or more layers. For example, but not limited to, each plastic sheet 20 could have a single layer of nylon or can have multiple layers of nylon and poly-ethylene. The plastic sheets 20 can also be enhanced by coating or metalizing to enhance the OTR such as, for example, metallized OPET, PVOH-coated OPP (AOH), metalized Biax Nylon-6, PVdC-coated OPET, high barrier PVdC-coated OPP, PvDC-coated Biax Nylon-6, metallized OPP, scalable PVdC-coated OPP, and the like. It is noted that the plastic sheets 20 can alternatively comprise any other suitable material and/or have any other suitable configuration.

The illustrated new paint applicator 12 is in the form a roller cover 24 but any other suitable type of new paint applicator 12 can alternatively be utilized such as, for example, a paint pad cover 26, a brush head 28, and the like. The illustrated roller cover 24 has an interior support tube 30 and the paint receiving portion 16 secured to an exterior surface of the support tube 30. The support tube 30 is sized and shaped to cooperate with a paint roller frame 32 having a handle 34 and a laterally extending roller 36 supported thereby. The roller 36 is rotatable relative to the handle 34. The roller cover 24 is selectively installed onto and removed from the roller 36 of the paint roller frame 32 and rotates as desired with the roller 36 during a painting operation (best seen in FIGS. 3 and 4). The support tube 30 can comprise any suitable material such as plastic, card board, paper board, and the like. The illustrated paint receiving portion 16 is secured to the exterior of the support tube 30 by an adhesive but any other suitable attachment means can alternatively be utilized. The width of the paint roller covers 24 is typically 2 to 18 inches. The illustrated paint roller cover 24 preferably has a width of about 2 to about 6 inches, and more preferably a width of about 4 inches but any other suitable width can alternatively be utilized. It is noted that the paint roller cover 24 can alternatively be any other suitable material, size and/or have any other suitable configuration.

The paint receiving portion 16 can be any suitable material that can absorb or soak up paint and then release a layer of the paint on surface to be painted when rolled along the surface to be painted. The rolling action creates a vacuum that pulls the paint off the roller cover 24. The paint receiving portion 16 of the paint roller cover 24 is typically a fiber such as, for example, lamb's wool, mohair, synthetic fabric, and the like, or foam such as, for example, Ethylene-vinyl acetate foam, urethane foam, and the like. Lamb's wool roller is best for oil-based paints and painting on any surface texture. Synthetic fabric is best for water-based paints and work for any surface textures. Foam is best with oil or high-gloss latex paints, and work best for smooth or textured surfaces. The thickness or length of the paint receiving portion's pile or nap can be any suitable thickness but is typically 1/16-inch to 1½-inch. It is noted that the paint receiving portion 16 of the paint roller cover 24 can alternatively be any other suitable material, size and/or have any other suitable configuration.

The illustrated new paint applicator 14 is pre-loaded with desired paint 18. That, is, the paint receiving portion 16 of the new paint applicator 14 has absorbed the desired amount, type and color of the paint 18 and is ready for painting prior to being sealed into the vacuum-sealed package 12. The paint 18 can be of any suitable type such as, for example, an oil-based paint, a water-based paint, a stain, and the like. The paint 18 can also be of any suitable color. The paint receiving portion 16 of the new paint applicator 14 is preferably pre-loaded with about 3 ounces or less of the paint 18, is more preferably, pre-loaded with about 2 ounces or less of the paint 18, and most preferably pre-loaded with about 1 ounce or less of the paint 18. The small quantity of paint 18 reduces waist when used as sample paint, touch-up paint, or the like.

The illustrated vacuum-sealed package 12 also includes content information 38 content information provided thereon. The Illustrated content information 38 is printed or marked onto a label 40 secured to an outside surface of the package with adhesive or the like but it is noted that the content information 38 can alternatively be directly printed or marked on the outside surface of the vacuum-sealed package 12. The illustrated content information 38 can include (1) paint brand; (2) paint product number; (3) paint name; (4) paint type (such as exterior or interior); (5) packaging date, and/or (6) expiration date or use by date. It is noted that the content information 38 can alternatively include any one or more of these items of information and/or can additionally include any other suitable item(s) of information relating the vacuum-sealed package 12 or its contents.

A method of making the pre-packaged and pre-loaded paint applicator assembly 10 includes the steps of obtaining the new paint applicator 14 such as the paint roller cover 24, and obtaining a suitable quantity of the paint 18 desired to be supplied for sampling or touch-up etc. The paint receiving portion 16 of the new paint applicator 14 is then loading with the paint 18. The new paint applicator 14 can be loaded with the paint 18 by soaking, dipping, rolling, spraying, rubbing, wiping, and/or the like. The pre-loaded new paint applicator 14 is then placed entirely within the package 12 such as the illustrated plastic bag through an opening. The pre-loaded new paint applicator 14 is then vacuum sealed within the package 12. The open end of the package 12 is placed within a vacuum chamber where a vacuum generating device removes air from the package 12. With the air removed, the flexible walls of the bag 12 collapse to closely conform to the shape of the pre-loaded new paint applicator 14. Once the air is removed from the package 12, a sealing device seals the open end of the package with the final thermal or heat weld 22. The pre-packaged and pre-loaded paint applicator assembly 10 can then be distributed or sold directly to consumers or to retailers for distribution or sale to consumers. The consumers can tear open the vacuum-sealed package 12, remove, the pre-loaded new paint applicator 14 from the package 12, attach the pre-loaded new paint applicator 14 to the handle 34, and use the relatively small quantity of paint 18 pre-loaded onto the paint receiving portion 16 of the new paint applicator 14 as a paint sample or as touch-up paint etc. The one-time use package 12 can be discarded. The above illustrated method enables relatively small quantity paint samples to be prepared and stored in advance of sale or distribution to consumers and/or off site of the location of sale or distribution to consumers.

FIGS. 5 and 6 illustrate a pre-packaged and pre-loaded paint applicator assembly 100 according to a second embodiment of the present invention. The second embodiment is substantially the same as the first embodiment except that the new paint applicator 14 of the second embodiment is a paint pad cover 76 instead of the paint roller cover 24 of the first embodiment.

The illustrated new paint applicator 14 of the second embodiment is in the form a paint pad cover 76. The illustrated paint pad cover 76 has a rigid backing plate 42 covered with the paint receiving portion 16 on one side. The backing plate 42 is sized and shaped to cooperate with a paint pad frame 44 having a handle 46 and an attachment portion or pad 48 supported thereby. The backing plate 42 can be selectively installed onto and removed from the attachment portion or pad 48 of the paint pad frame 44 so that the paint pad cover 26 moves with the paint pad frame 44 during a painting operation (best seen in FIGS. 7 and 8). The backing plate can comprise any suitable material such as plastic, metal, and the like. The illustrated paint receiving portion 16 is secured to the front side of the backing plate 42 by an adhesive but any other suitable attachment means can alternatively be utilized. The width of the paint pad cover 26 is typically 2 to 9 inches. The illustrated paint pad cover 26 preferably has a width of about 3 to about 5 inches, and more preferably a width of about 4 inches but any other suitable width can alternatively be utilized. It is noted that the paint pad cover 26 can alternatively be any other suitable material, size and/or have any other suitable configuration.

The paint receiving portion 16 can be any suitable material that can absorb or soak up paint and then release a layer of the paint on surface to be painted when rubbed or wiped across the surface to be painted. The wiping action rubs the paint off the paint pad cover 26 onto the surface to be painted. The illustrated paint receiving portion 16 is a pad of plastic foam faced with nylon fiber pile. However, the paint receiving portion 16 can alternatively comprise brush bristles, open cell foam, woven fabric, and/or various other fluid absorbing or wicking material suitable for painting. It is noted that the paint receiving portion 16 of the paint pad cover 26 can alternatively be any other suitable material, size and/or have any other suitable configuration.

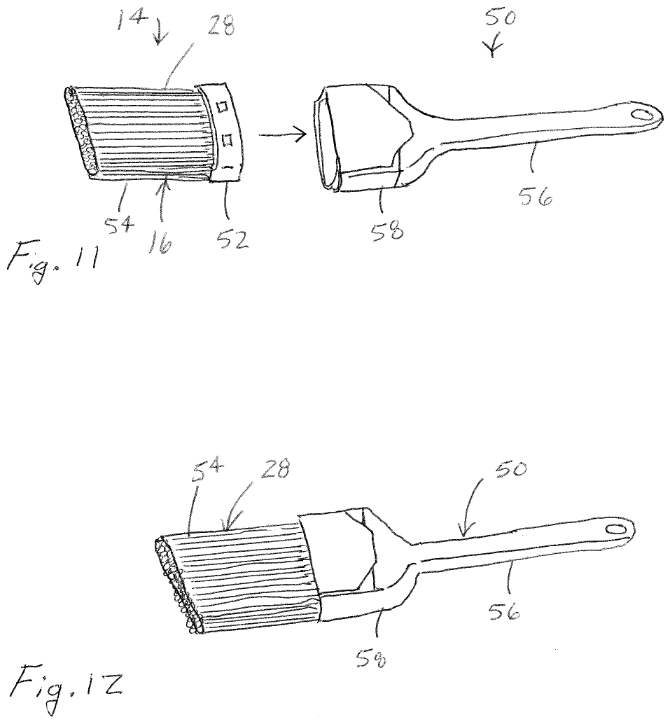

FIGS. 9 and 10 illustrate a pre-packaged and pre-loaded paint applicator assembly 200 according to a third embodiment of the present invention. The third embodiment is substantially the same as the first embodiment except that the new paint applicator 14 of the third embodiment is a paint brush head 28 for a paint brush frame 50 instead of the paint roller cover 24 for a paint roller frame 32 of the first embodiment.

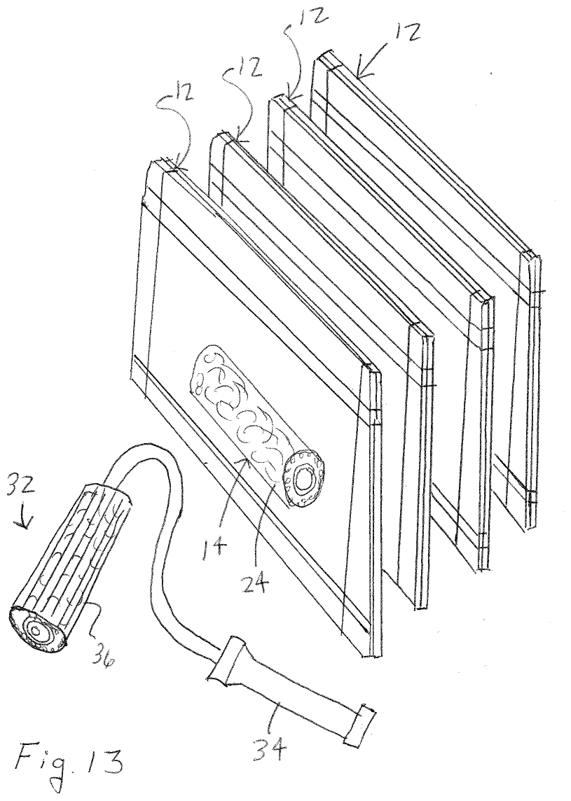

The illustrated new paint applicator 14 of the third embodiment is in the form a paint brush head 28. The illustrated paint brush head 28 has a rigid bristle holder 52 with the paint receiving portion 16 in the form of a plurality of bristles 54 extending from one side. The bristle holder 52 is sized and shaped to cooperate with a paint brush frame 50 having a handle 56 and an attachment portion 56 supported thereby. The bristle holder 52 is selectively installed onto and removed from the attachment portion 58 of the paint brush frame 50 and moves with the paint brush frame 50 as desired during a painting operation (best seen in FIGS. 11 and 12). The bristle holder 52 can comprise any suitable material such as plastic, metal, and the like. The illustrated paint receiving portion 16 is secured to the front side of the bristle holder 52 by an adhesive but any other suitable attachment means can alternatively be utilized. The width of the paint brush head 28 is typically 1 to 6 inches. The illustrated paint brush head 28 preferably has a width of about 3 to about 4 inches, and more preferably a width of about 3.5 inches but any other suitable width can alternatively be utilized. It is noted that the paint brush head 28 can alternatively be any other suitable material, size and/or have any other suitable configuration.

The paint receiving portion 16 can be any suitable plurality of bristles 54 that can absorb or soak up paint and then release a layer of the paint 18 on surface to be painted when rubbed or wiped across the surface to be painted. The wiping action rubs the paint off the bristles 54 onto the surface to be painted. The bristles 54 can be any suitable natural or synthetic material. Natural bristles are typically made from some sort of animal hair, such as hog or badger. Synthetic bristles are typically made from nylon, polyester, or a combination of both. Natural-bristles are best for applying oil-based alkyd paints, and synthetic-bristles are best for applying water-based latex paints. It is noted that the paint receiving portion 16 of the paint brush head 28 can alternatively be any other suitable material, size, and/or have any other suitable configuration.

As shown in FIG. 13, the pre-packaged and pre-loaded paint applicators assemblies 10 can form a kit 60 comprising any quantity of the vacuum-sealed packages 12 with the vacuum-sealed packages each including one or more different colors of paint 18 to be sampled or used for touch up. When the paint 18 is to be used as sample paint, each of the vacuum-sealed packages 12 typically include a different colors of paint 18. When the paint 18 is to be used as touch-up paint, the vacuum-sealed packages 12 typically include the same color of paint 18. The kit 60 can also include a handle 34, 46, 56 suitable for use with the enclosed new paint applicators 14 such as a paint roller frame 32 when vacuum-sealed packages 12 include the pre-loaded paint roller covers 24, the paint pad frame 44 when the vacuum-sealed packages 12 include the pre-loaded paint pad covers 26, and the paint brush frame 50 when the packages include pre-loaded paint brush heads 28.

Any of the features or attributes of the above-described embodiments and variations can be used in combination with any of the other features and attributes of the above-described embodiments and variations as desired.

From the foregoing disclosure and detailed description of certain exemplary embodiments, it will be apparent that the illustrated pre-packaged and pre-loaded paint applicators provide an efficient and inexpensive way to distribute a small quantity of paint such as, for example, paint color samples, touch-up paint, and the like. It will also be apparent that the illustrated pre-packaged and pre-loaded paint applicators provide an efficient and inexpensive method to produce paint color samples, touch-up paint, and the like in advance and/or off-site so that retail employees are not required to prepare cans of color sample of touch-up paint on-site and on-demand. Additionally, the above-described packages and methods are more environmentally friendly than prior art because there is less wasted paint that must be disposed.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. A pre-packaged paint applicator comprising, in combination:
a package; and
a new paint applicator sealed within the package and having a paint receiving portion pre-loaded with paint.

2. The pre-packaged paint applicator according to claim 1, wherein the package is a bag comprising plastic.

3. The pre-packaged paint applicator according to claim 1, wherein the paint applicator is a paint roller cover.

4. The pre-packaged paint applicator according to claim 1, wherein the paint applicator is a paint pad.

5. The pre-packaged paint applicator according to claim 1, wherein the paint applicator is a paint brush head.

6. The pre-packaged paint applicator according to claim 1, wherein the package is provided with content information including at least one of a paint product number, a paint color name, a packaging date, or an expiration date.

7. A method for providing a paint sample comprising the steps of, in combination:
pre-loading a paint receiving portion of a new paint applicator with paint;
placing the pre-loaded paint receiving portion of the new paint applicator into a package;
sealing the pre-loaded paint receiving portion of the new paint applicator within the package; and
distributing the pre-packaged and pre-loaded paint applicator.

8. The method for providing a paint sample according to claim 7, further comprising the step of repeating the pre-loading and sealing steps to form a plurality of the new paint applicators each packaged and pre-loaded with a different color of the paint.

9. The method for providing a paint sample according to claim 7, wherein the package is a bag comprising plastic.

10. The method for providing-paint-samples a paint sample according to claim 7, wherein the paint receiving portion is a paint roller cover.

11. The method for providing a paint sample according to claim 7, wherein the paint receiving portion is a paint pad.

12. The method for providing a paint sample according to claim 7, wherein the paint receiving portion is a paint brush head.

13. The method for providing a paint sample according to claim 12, further comprising the further step of providing the package with content information including at least one of a paint product number, a paint color name, a packaging date, or an expiration date.

14. A kit comprising, in combination:
a plurality of pre-packaged paint applicators each comprising
a sealed package; and
a new paint applicator sealed within the package and having a paint receiving portion pre-loaded with paint.

15. The kit according to claim 14, wherein each of the paint receiving portions are pre-loaded with a different color of paint.

16. The kit according to claim 15, further comprising a handle configured for removable attachment to the paint applicators.

17. The kit according to claim 15, wherein each of the packages is a bag comprising plastic.

18. The kit according to claim 15, wherein each of the paint applicators is a paint roller cover.

19. The kit according to claim 6, wherein each of the paint applicators is a paint pad cover.

20. The kit according to claim 6, wherein each of the paint applicators is a paint brush head.
